(19) United States
(12) Patent Application Publication
(10) Pub. No.: US 2015/0080082 A1
(43) Pub. Date: Mar. 19, 2015

(54) LOTTERY GAME BASED ON DATES AND METHOD OF PLAYING A LOTTERY GAME BASED ON DATES

(71) Applicant: Ahmnon D. MOSKOWITZ, Rockville, MD (US)

(72) Inventor: Ahmnon D. MOSKOWITZ, Rockville, MD (US)

(21) Appl. No.: 14/467,006

(22) Filed: Aug. 23, 2014

Related U.S. Application Data
(60) Provisional application No. 61/869,645, filed on Aug. 23, 2013.

(51) Int. Cl. G07F 17/32

(52) U.S. Cl. CPC G07F 17/329
USPC 463/17

(57) ABSTRACT

A lottery game allowing the player to make selections from a plurality of parameters. The parameters each represent specific units of time as well as astrological signs. The player can either pick the variables within the parameters or choose to have the computer select them. The player picks one or more parameters from the plurality of parameters. If the variables picked by the player or the computer match the variables picked by the gaming operator, the player will receive a corresponding payout.

### CROSS-REFERENCE TO RELATED APPLICATIONS

This application is a non-provisional application, for which priority is claimed under 35 U.S.C. §119, of copending U.S. Provisional Patent Application No. 61/869,645, filed Aug. 23, 2013, and entitled “LOTTERY GAME BASED ON DATES AND METHOD OF PLAYING A LOTTERY GAME BASED ON DATES,” the entire contents of the above identified patent application is incorporated herein by reference in its entirety.

### FIELD OF THE INVENTION

The present invention generally relates to a lottery game, and more particularly, to a lottery game in which player selected numbers and/or symbols based on dates are compared to winning numbers and/or symbols based on dates for determining a value payout to the player.

### BACKGROUND OF THE INVENTION

A typical conventional lotto game in the United States involves a plurality of parameters and a plurality of variables within the parameters. Generally, the variables range from zero or one to X. The odds of winning the top prize can be altered by increasing the parameters and making X a larger or smaller number. The “pick 3” and “pick 4” are examples of lottery number games. Three or four digits are chosen, and the lottery system picks the winners. If the player's numbers match the lottery's numbers in exact order, a top prize is awarded. Other features include a system where a player can match the two front digits, the two back digits, the first and last digit, or some combination of the above. Other lottery games include the “mega millions” and “Powerball” where six numbers are drawn and if a player matches all numbers there is a grand prize with subordinate payouts for the matching part of the numbers.

Several types of conventional lottery systems have been proposed. Such conventional lottery systems include, but are not limited to: (i) automated lottery systems; (ii) video lottery systems; (iii) lottery systems with pluralities of parameters and variables; (iv) lottery systems having two pools of numbers; (v) lottery systems where a player inputs a specific date and a lottery number is chosen for the player to play; (vi) and lottery systems where numerical date-time and astrological fields serve as an inspiration to the player as to which numerical selections to make. Below, some examples of conventional art related to the aforementioned lottery systems is described.

The following U.S. patents describe various conventional automated lottery systems: U.S. Pat. No. 4,033,588 to Watts; U.S. Pat. No. 4,277,064 to Newman; U.S. Pat. No. 4,323,770 to Dieulot, Juan, and Fardeau; U.S. Pat. No. 4,494,197 to Troy and Mullenix; U.S. Pat. No. 4,689,742 to Troy and Mullenix. U.S. Pat. No. 7,662,038 to Bozeman describes a lottery game with a plurality of parameters and variables. The following two U.S. patents describe video lottery systems: U.S. Pat. No. 5,380,007 to Travis and Travis; U.S. Pat. No. 6,168,521 to Luciano, Bunce, Feldman, Forman, and Levine. U.S. Pat. No. 5,511,784 to Furry and Tode descibes one of the many means the lottery game systems select winners. U.S. application Pub. No. US 2004/0173965 to Stanek describes a lottery having two pools of numbers. U.S. Pat. No. 5,118,110 to Jones describes a lottery number selector where a player inputs a specific date and a lottery number is chosen for the player to play. U.S. Pat. No. 6,802,506 to Spende is a calendar based game, similar to U.S. Pat. No. 5,118,110 to Jones, where a player can choose an entry number based on a specific point of time however the chosen numbers generally are not in correspondence to a specific moment time. U.S. Pat. No. 6,802,506 to Spende features numerical date-time and astrological fields where date, numerology, and astrology related events provide the inspiration to the player as to which numerical selections to make. However, the player does not choose dates, but numbers that he may connect with dates. The numerical date-time and astrological fields serve only as an inspiration to the player.

### SUMMARY OF INVENTION

The present application recognizes that lotteries have evolved over decades, generating increasing revenue year after year. However, after decades of growth, the sales curves associated with the lotteries seem to be flattening out. Consequently, both lotteries and their service providers are presently searching for new forms of gaming.

Many times players pick numbers based on dates they feel have some significance to them. For example, the players can pick numbers related to birthdays and wedding days. Therefore, a lottery game allowing the players to pick dates, not just numbers, will provide players with a new and different lottery experience.

The conventional art contains games that contain parameters and variables that are inconsistent with time units. For example, in “Powerball,” if a player wanted to choose a month they can pick up to 12, since there are 56 numbers a player might have a sense of inequity. If a player wanted a year like 1993, they would also have to use some other form of substitute since there is no 93. The “pick 4” has a better compatibility with dates since there are four parameters with variables {0 to 9}. So one could pick variables based on months or days, {, 01, 02, 03 . . . , 10, 11 12} and {1, 2, 3 . . . 29, 30, 31}. A drawback of the “Pick 4” is that there is a great deal of excessive variables unrelated to most dates.

A game entitled “MyDaY”, previously known as “Dato,” offered by Nebraska Lottery, allows the players to choose a six-digit date for each play. The six-digit date consists of one number from 1 to 12 for the month, one number from 1 to 31 for the day, and two numbers from 0 to 9 for the last digits of the year. Although the game “MyDaY” allows the players to pick dates, it has several disadvantages, namely for example:
the game does not allow the player to pick plurality of days, months and years for each play.
the game does not allow the gaming operator to select winners by picking one or more dates from a set of dates and assessing the extent to which the picked numbers match two or more dates picked by a player.
the game does not allow the gaming operator to select winners by picking at least a year from a set of years and assessing the extent to which the picked year match one or more years picked by a player from a set of years.

Consequently, the game “MyDaY” lacks many functionalities which will make a game based on dates more attractive for players. Herein, the present application describes a game of chance adapted to be played in relation to units of times. This game can be played by anyone but more specifically it is geared towards those who feel the need to pick numbers based on specific dates. The exemplary game is an improvement of the conventional art.

The present invention provides a lottery game that enables the players to pick numbers based on dates they feel have some significance to them. It further provides a game that allows the players to pick dates from various civil calendars, including the Gregorian calendar. The invention also allows the players to pick astrological signs. Furthermore, the invention allows players to pick time parameters representing minutes, hours, and weeks. Moreover, the invention allows a player to pick the full number of the year, e.g. 2012. In addition, the invention allows a gaming operator to select winners by relating the dates chosen by players to astrological signs (preferably from the Chinese zodiac) picked by the gaming operator. The invention also allows the players to pick plurality of days, months and years for each play. Furthermore, the invention allows the gaming operator to select winners by picking one or more dates from a set of dates and assessing the extent to which the picked numbers match two or more dates picked by a player. It further allows the gaming operator to select winners by picking at least a year from a set of years and assessing the extent to which the picked year match one or more years picked by a player from a set of years.

In accordance with an exemplary embodiment, a game allows the player to make selections from a plurality of parameters. The parameters each represent specific units of time, namely, days, months, and years. The player can either pick the variables within the parameters or choose to have the computer select them. The player picks at least one day, one month, and one year from the plurality of parameters. If the variables picked by the player or the computer match the variables picked by the gaming operator, the player will receive a corresponding payout.

In accordance with another embodiment, the game allows the player to make selections from days from calendar years. The player picks at least one day from a calendar year and the gaming operator picks a plurality of days from a calendar year. The player can either pick the day(s) from a calendar year or choose to have the computer pick the day(s). If the day(s) picked by the player or the computer match(es) the days picked by the gaming operator, the player will receive a corresponding payout.

In accordance with another embodiment, the game allows the player to make selections from a plurality of parameters. The parameters each represent specific units of time, namely, days, months, and astrological signs. The player picks at least one day, one month, and one astrological sign from the plurality of parameters. The player can either pick the variables within the parameters or choose to have the computer pick them. If the variables picked by the player or the computer match the variables picked by the gaming operator, the player will receive a corresponding payout.

Accordingly, several advantages of one or more aspects of the exemplary games are that the game allows the player to pick plurality of days, months, and years for each play. Other advantages of one or more aspects are that the game allows the gaming operator to select winners by picking one or more dates from a set of dates and assessing the extent to which the picked numbers match two or more dates picked by a player. Other advantages of one or more aspects are that the game allows the gaming operator to select winners by picking at least a year from each set of years and assessing the extent to which the picked year match one or more years picked by a player from a set of years. Other advantages of one or more aspects are that the game allows the players to pick dates from various civil calendars, including the Gregorian calendar. Other advantages of one or more aspects are that the game allows the players to pick astrological signs. Other advantages of one or more aspects are that the game allows a player to pick the full number of the year, e.g. 2012. Other advantages of one or more aspects are that the game allows a gaming operator to select winners by relating the dates chosen by players to astrological signs picked by the gaming operator. Other advantages of one or more aspects are that the game allows the players to pick plurality of days, months and years for each play. These and other advantages of one or more aspects will become apparent from a consideration of the ensuing description and accompanying drawings.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 illustrates a sample bet sheet according to an exemplary embodiment of the invention.

FIG. 2 illustrates an alternate form of betting in the year parameter where one indicia represents multiple years, according to an exemplary embodiment of the invention.

FIG. 3 illustrates astrological signs that can be marked alongside or in place of time units in the exemplary embodiment of FIG. 1.

FIG. 4 illustrates indicia for Chinese zodiac year symbols, according to an exemplary embodiment of the invention.

FIG. 5 illustrates an alternative bet sheet format allowing a player to make selection with indicia representing calendar year, according to an exemplary embodiment of the invention.

FIG. 6 illustrates a bet sheet indicating a player to play a combination of two or three dates in a year for a single game against the gaming operator's draw of two or more dates, according to an exemplary embodiment of the invention.

FIG. 7 illustrates a bet sheet indicating a player to play a combination of four dates for a single game against the lottery operator's selection of five dates, according to an exemplary embodiment of the invention.

FIG. 8 illustrates a game where a player selects two specific dates including a day, a month and a year, according to an exemplary embodiment of the invention.

FIG. 9 illustrates a keno like embodiment where a player can select from one to ten dates and the gaming operator would select twenty with payouts corresponding to the chances of a player matching the variables, according to an exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

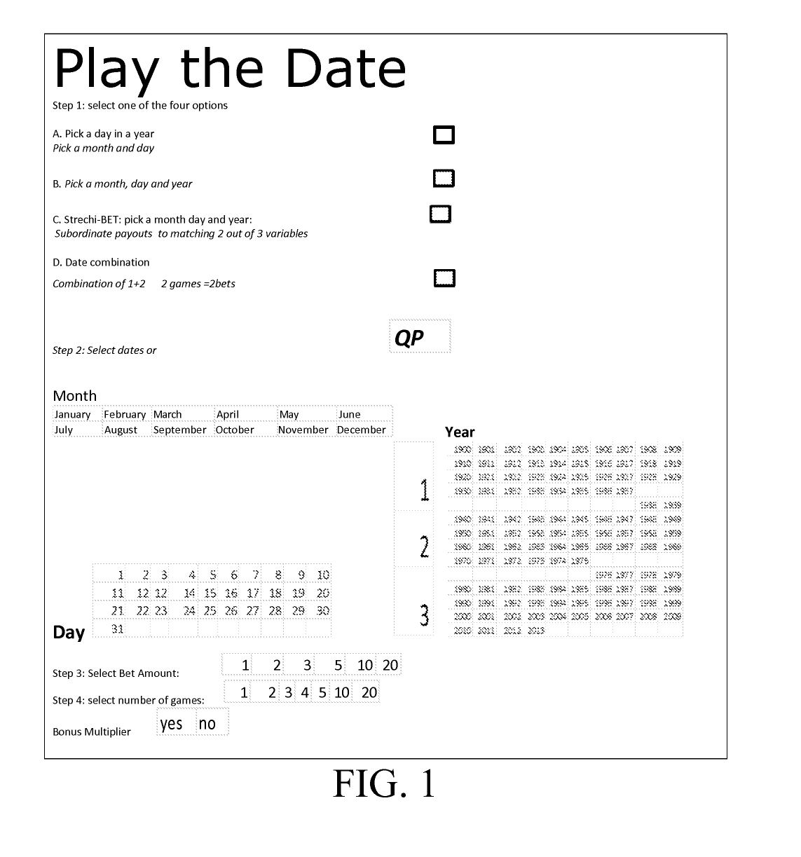

An exemplary embodiment of a game is illustrated in FIG. 1. FIG. 1 displays a sample bet sheet for the game. The sheet includes four sections entitled “Step 1,” “Step 2”, “Step 3”, and “Step 4.” Step 1 includes four paragraphs entitled as follows: “A. Pick a day in a year,” “B. Pick a month, day, and year,” “C. Strechi-BET: pick a month day and year,” and “D. Date combination.” Each paragraph also includes an indicia.

Step 2 includes three tables, namely, “Month”, “Year”, and “Day.” The table “Month” includes twelve indicia. Each rectangle refers to one of the calendar months (e.g. January, February, and March). The Table “Year” includes two tables, namely, a left table and a right table. The left table includes three indicia displaying the numbers 1, 2, 3, respectively. The right table includes 140 indicia. In these 140 indicia, there are three rows of years referring to each of the numbers in the left table. The first row of years begins with 1900 and finishes at 1937. The second row of years begins with 1938 and finishes at 1975. The third row of years begins with 1976 and finishes at 2013. The Table entitled “Day” includes 40 indicia. 31 of these indicia contain numbers starting from 1 and finishing at 31. These numbers represent the different days of a calendar month.

Step 3 includes a text “Bet Amount” and six indicia displaying the following numbers, respectively: 1, 2, 3, 5, 10, 20.

Step 4 includes a text “Select number of games” and seven indicia displaying the following numbers, respectively: 1, 2, 3, 4, 5, 10, 20. Step 4 also includes a text “Bonus Multiplier” and two indicia displaying the following words, respectively: “Yes” and “No.”

An example operation of the embodiment in FIG. 1 will now be described.

In order to play the game, the player needs to mark certain boxes in each of the four steps. The player chooses one of the four options listed in Step 1. In Step 2, the player picks the relevant dates depending on the option chosen by him. In Step 3, the player chooses the bet amount. In Step 4, the player chooses the number of the games he would like to play.

After the player completes the bet sheet, the gaming operator will choose the winning variables. The winning variables can be chosen mechanically, manually, or by a computer.

For payouts a game operator has the choice of having a payout for matching only exact variables or having subordinate prizes for matching part of the winning variables. For example, if a player picks day/month/year to win, a rule can be written to award a player that matches a plurality of variables.

The payout can vary depending on the game operator. For a day in a year, the probability of winning is approximately 1/365. If there would be three winners the probability of winning would be 3/365 increasing the odds of winning and reducing the payout. The probability of hitting an exact day/month/year/match is approximately 365*the variables in the year parameter.

In a game where for the top payout a player is required to match a plurality dates from a calendar year to the gaming operators selections, the odds go down as the number of required variables go up, hence it would be preferable that the payout should increase accordingly. For example the probability of winning two date draws out of two would be (366*365)/2=1/66,795. Three out of three dates 366*365*364/3*2=1/8,104,460. Of matching four out of five dates (366*365*364*363)/(5*4*3*2)=1:147,095,949. For the larger jackpots, it would make sense to offer a top payout corresponding to the odds and subordinate payouts awarded for matching lesser variables. When a player is required to select more dates, it make sense to offer a starting jackpot and for it to increase progressively after each game in which no player matches all the variables.

The approximate probability of hitting a month is one in 12, slightly less for February and slightly more for the months with 31 days. The approximate probability for hitting a day variables vary: February has 28 or 29 days, followed by April, May, June, September, and November having 30 days, and the others include 31. If the lottery operator wanted they could have the same payout for matching the day variable. Alternatively they can alter the payouts to correlate to the frequency of occurrence {1-28}, {29}, {30}, and {31} each having a different payout. If the operator wanted to simplify the payout system the operator would have one payouts for the variables {1-30} and another for the {31} variable. The probability of the year variable occurring would be approximately the number of variables in the year parameter(s).

Another parameter that is common in state lotteries that can be used in conjunction with this lottery game is a “multiplier”. A player marks the “multiplier option” increasing the wager amount. The gaming operator selects a multiplier and the players winnings would be increased by the multiplier factor.

The results can either be generated by a computer, drawn manually, or mechanically. In the lottery game either a player would select the appropriate criteria or choose to have the computer select them. A teller could enter the bets manually or a bettor takes a betting slip and marks the indicia and the slip is inputted through a terminal. The terminals can either be stand alone and in the case of state lotteries there would be a multitude of them and they would be connected to a centralized computer system.

The lottery system has multiple terminals that send and receive data via a centralized processing unit. The lottery central processor is connected to a multitude of remote terminals with each terminal having the ability of sending and receiving data inputs to the central processing unit, with such data inputs including the identification of the playing console, the amount played, and the games selected which could be instant game or a delayed game. The terminal will either accept or reject the bet determining if it is valid or not. A ticket identifying the characteristics of the bet would be printed. A means of verifying the validity of the ticket would also be printed on the ticked.

In the exemplary embodiment, a player has six ways to play. These six ways are described below.

1) Exact date:

The player selects a plurality of parameters with separate variables and wagers that the variables occur in the game simultaneously. For example: a specific month, day, and or a year. For example a player picks “November 10”. If “November 10” is drawn the player would be entitled to the corresponding payout.

2) Place or Show:

The player or computer chooses a variable or multiple variables within the parameters. The player is wagering on a single variable occurring: for example “the month of November” or the “23” of any month” or “the year 1930” If any of those are drawn the player wins the corresponding prize.

3) Exact date/Show (place) combination:

The player can choose to play a combination of an exact date and a show. For example if “September 21” is selected the player would be placing 3 bets (i), that September would show and (ii) that 21 would show and (iii) both variables “September” and “21” occur simultaneously. For example, if February 21 or September 15 showed, the player would win the show game and loose the exact date game. If “September 21” was drawn the player, would win all three games.

4) Day-month/day-month year combination:

A player selects a day in a calendar year and a year variable. For example a player can select “September 21” 1987 with the calendar day “September, 21” being one game and the exact date “Sep. 21, 1987” being an additional game.

5) Multi-date combination:

This is a variation of the “Exact date” option. This involves a game play that will require a plurality of winning variables to win. The player chooses at least one variable in one parameter and a plurality of variables in another parameter.

The amount of bet would be based on the total number of combinations. For example, a player selects “September” in the month parameter and “23” and “25” in the day parameter. That would be 2 Bets: the player is wagering that either (i) “September 23” or (ii) “September 25” will be drawn. Another example would be if player marks “September”, “July” and the days “23”, “25” and the years “1980” and “1963”. In this case the player would be placing six Bets since there are a total of six combinations.

6) A multi-choice combination bet “way bet”:

Normal single bets can be combined with multi-choice single bets. For example in a game where a player can pick up to three dates a player can select a “way bet” which would be up to 7 games in total. One for the game of matching three out of three dates, three games for matching two dates and three games for matching a single date.

The game can be played whereby there are daily drawings like the pick 3 and 4, or by continuous play like Keno, video poker or an instant ticket. The instant ticket variation is a single player game; a player inputs a date and indicates to play a single game or a plurality of games. For example a player can choose the date “August, 30” and select to play against two draws, which would be two bets. Alternatively, a player can select multiple date combinations against one or a plurality of gaming operator's selection. For example a player will select “August 30” and “August 26” the gaming operator would draw one winning date against the player's selection; that would also be two games or bets. The two aforementioned can be combined where a player selects multiple games for the gaming operator to return with multiple draws. The amount of games would be based on the total number of combination of games. For example a player can select three date combinations and select that the gaming operator draws two date combinations; this would be a total of six bets or games. Another feature common with the game is a “second chance drawing” whereby ticketholders have a chance of winning in a new draw.

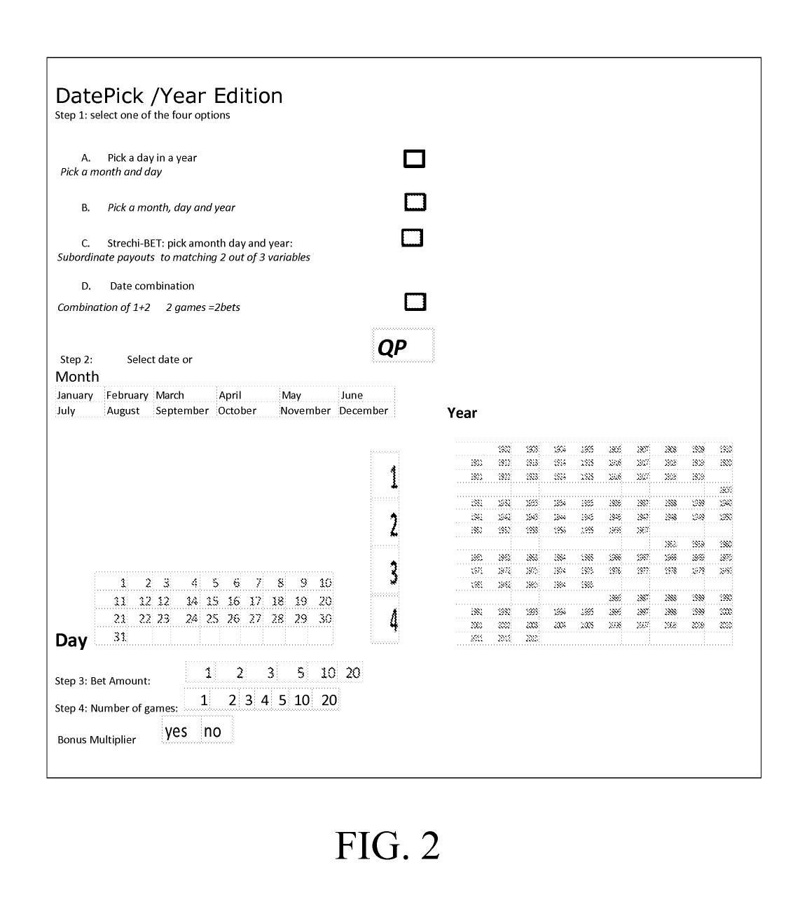

With reference to FIGS. 2-9, additional exemplary embodiments will now be described.

FIG. 2 refers to an embodiment that is similar to the embodiment in FIG. 1. The difference between the two embodiments is in the table “Year” of Step 2. In FIG. 2, the left table includes four indicia displaying the numbers 1, 2, 3, 4 respectively. The right table includes 150 indicia. In these 150 indicia, there are four rows of years referring to each of the numbers of the left table. The first row of years begins with 1902 and finishes at 1929. The second row of years begins with 1930 and finishes at 1957. The third row of years begins with 1958 and finishes at 1985. The fourth row of years begins with 1986 and finishes at 2013. The Table entitled “Day” includes 40 indicia. 31 of these indicia contain numbers starting from 1 and finishing at 31. The objective of this embodiment is to ensure that year parameter has an equal set of leap years.

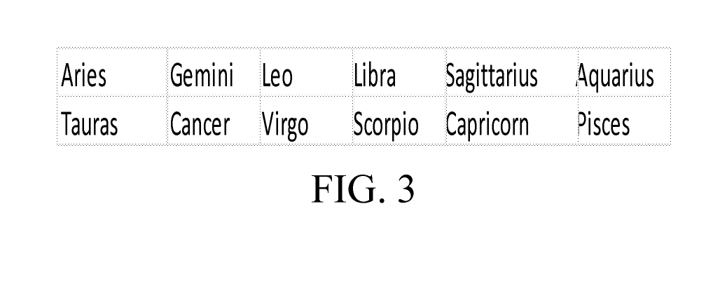

FIG. 3 refers to an embodiment that is similar to the embodiment in FIG. 1. The only difference between the two embodiments is that the embodiment in FIG. 3 has an additional table including twelve indicia displaying the twelve astrological signs. Thus, the embodiment in FIG. 3 allows the player to pick not only the dates mentioned in FIG. 1, but also astrological signs.

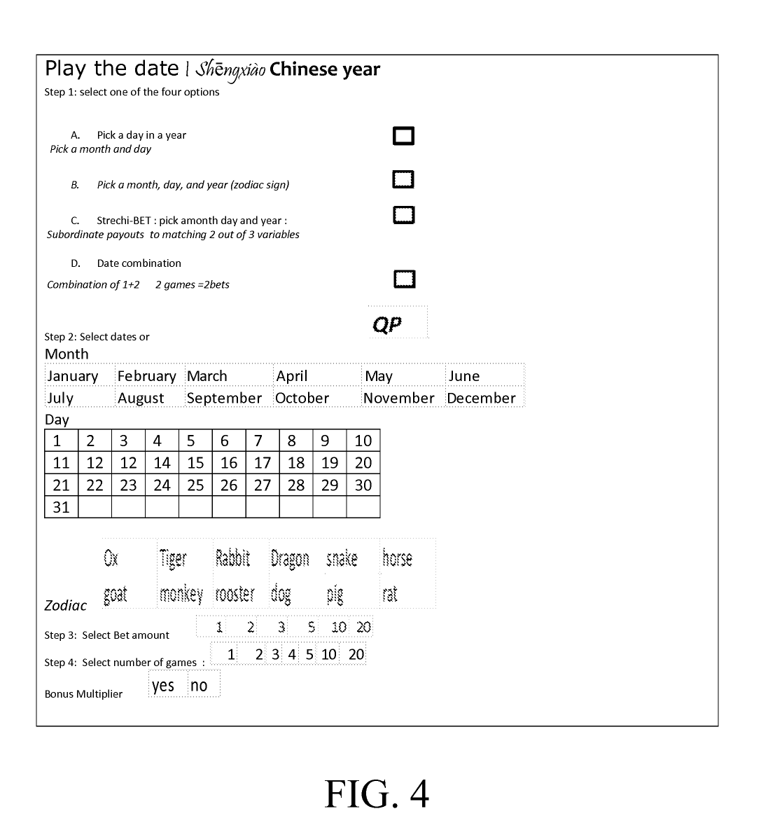

FIG. 4 illustrates an embodiment that is similar to the embodiment in FIG. 1. The only difference between the two embodiments is that Step 2 includes three tables, namely, “Month”, “Day,” and “Zodiac.” The table “Zodiac” includes twelve indicia displaying the twelve signs of the Chinese zodiac, respectively.

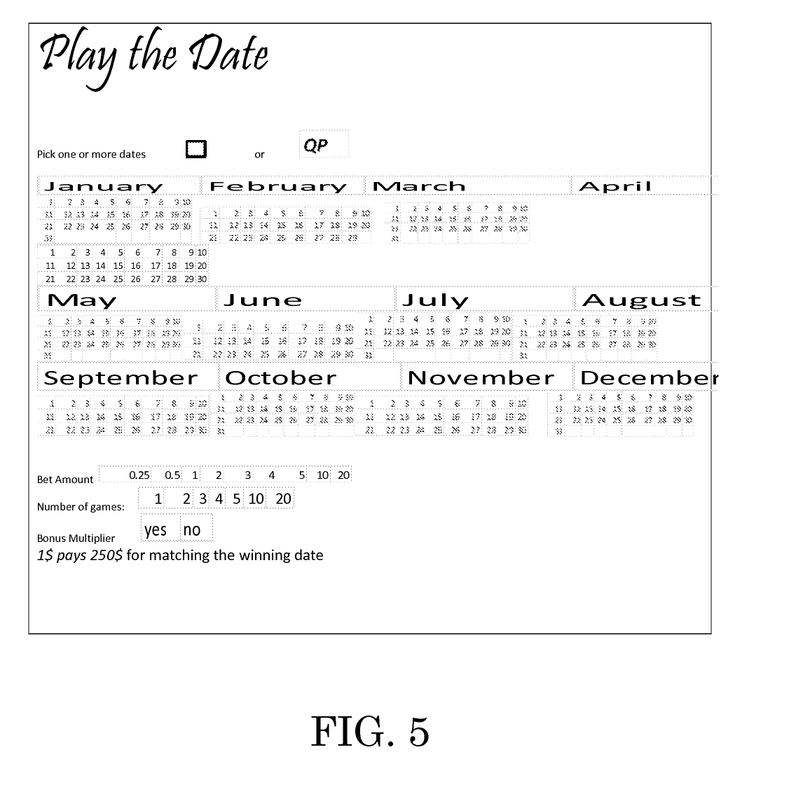

FIG. 5 illustrates an embodiment of the game allowing the player to choose one or more dates from a calendar year. At the top of FIG. 5, there is a calendar of a year including months and dates. At the bottom of FIG. 5, there is a text “Bet Amount” and nine indicia displaying the following numbers, respectively: 0.25, 0.5, 1, 2, 3, 4, 5, 10, 20. At the bottom of FIG. 5, there is a text “Select number of games” and seven indicia displaying the following numbers, respectively: 1, 2, 3, 4, 5, 10, and 20. By marking one of the indicia, the player chooses the number of games that he/she wants to play. At the bottom of FIG. 5, there is also a text “Bonus Multiplier” and two indicia displaying the following words, respectively: “Yes” and “No.” At the bottom of FIG. 5, there is also a text “1$ pays 250$ for matching the winning date.”

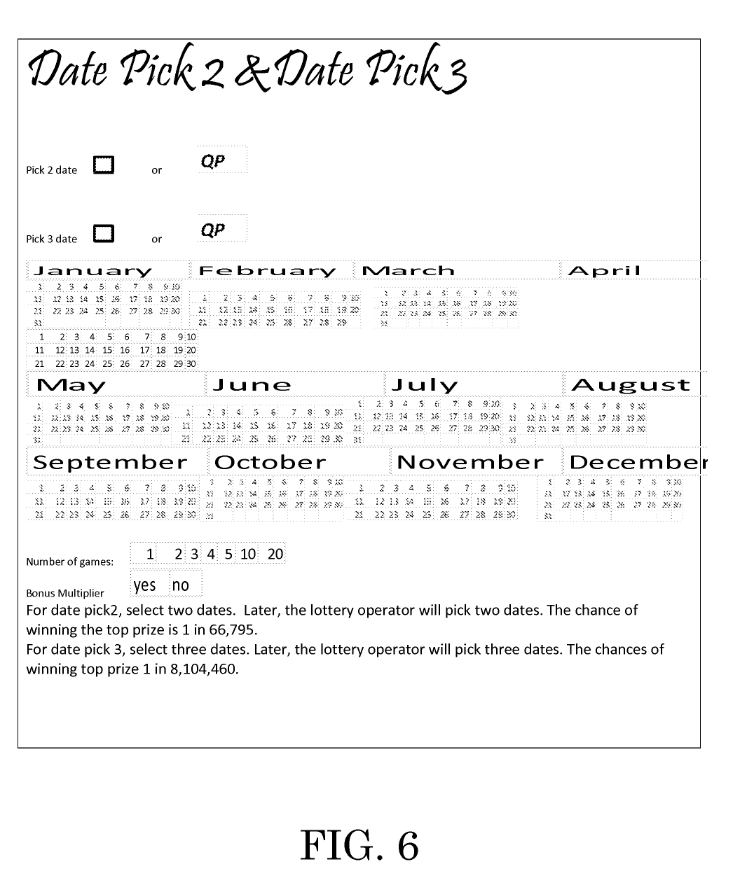

FIG. 6 illustrates an embodiment of the game allowing the player to pick two or three dates. At the top of FIG. 6, there are two lines of text, namely, “Pick 2 date” and “Pick 3 date.” Each line also includes a box. By marking the box, the player chooses his preferred option. At the top of FIG. 6, there is a calendar of a year including months and dates. At the bottom of FIG. 6, there is a text “Select number of games” and seven indicia displaying the following numbers, respectively: 1, 2, 3, 4, 5, 10, 20. By marking one of the indicia, the player chooses the number of games that he/she wants to play. At the bottom of FIG. 6, there is also a text “Bonus Multiplier” and two indicia displaying the following words, respectively: “Yes” and “No.” At the bottom of FIG. 6, there is also a text “For date pick 2, select two dates. Later, the lottery operator will pick two dates. The chance of winning the top prize is 1 in 66,795” and a text “For date pick 3, select three dates. Later, the lottery operator will pick three dates. The chance of winning the top prize is 1 in 8,104,460.”

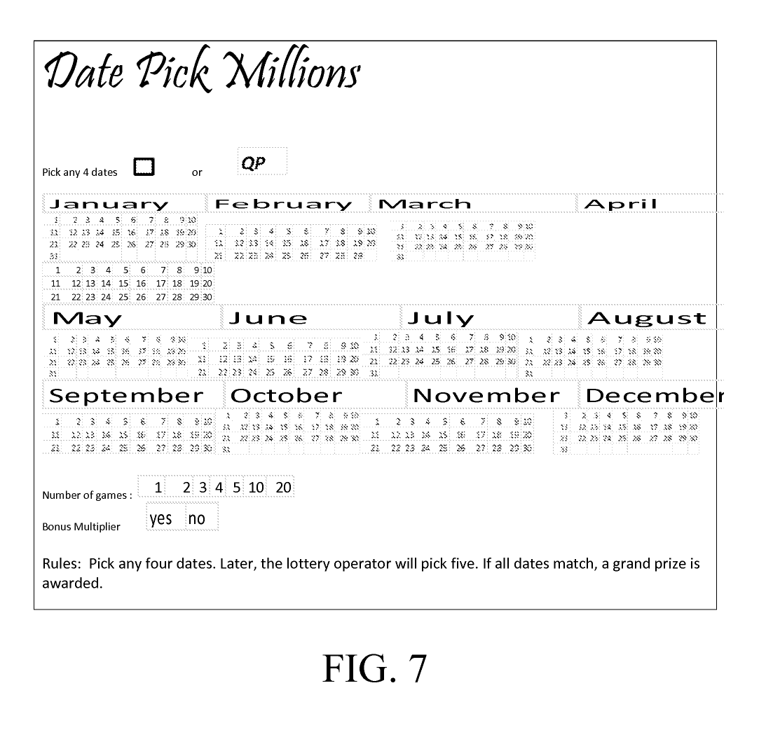

FIG. 7 illustrates an embodiment of the game allowing the player to pick four dates. At the top of FIG. 7, there is a calendar of a year including months and dates. At the bottom of FIG. 7, there is a text “Select number of games” and seven indicia displaying the following numbers, respectively: 1, 2, 3, 4, 5, 10, 20. By marking one of the indicia, the player chooses the number of games that he/she wants to play. At the bottom of FIG. 7, there is also a text “Bonus Multiplier” and two indicia displaying the following words, respectively: “Yes” and “No.” At the bottom of FIG. 7, there is also a text “Rules: Pick any four dates. Later, the lottery operator will pick five dates. If all dates match, a grand prize is awarded.” It should be noted that, in this embodiment, a player can choose fewer dates than what the gaming operator draws. For example, if a gaming operator has a game that draws four dates, a player can select to draw one, two, three, or four.

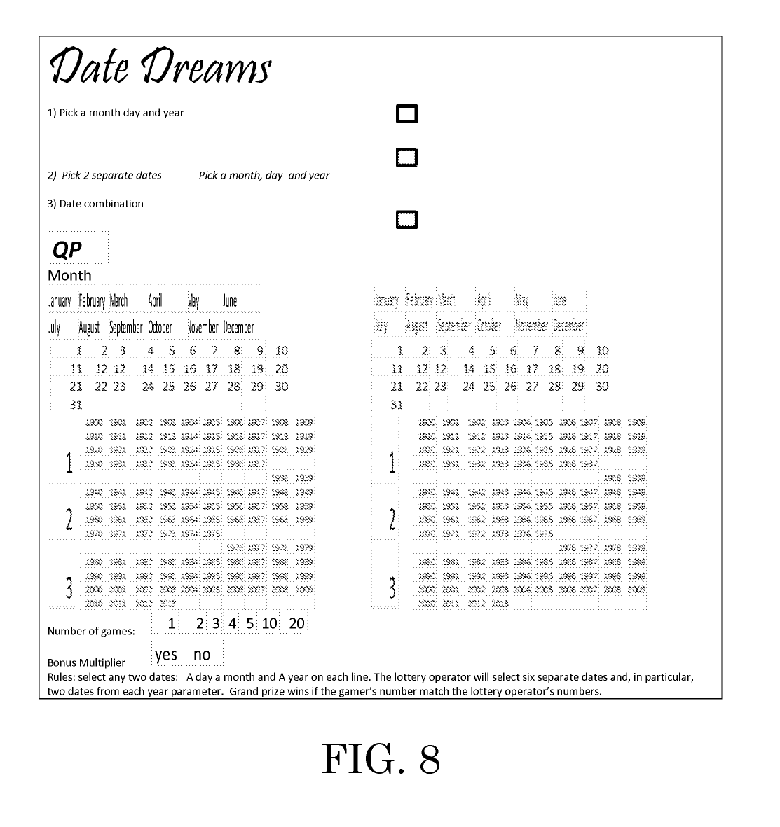

FIG. 8 refers to an embodiment of the game allowing the player to choose one of three options, namely: (1) pick a month, day, and a year; (2) pick two separate dates including a month, day, and a year; (3) pick a date combination. At the top of FIG. 8, there is a calendar of a year. The calendar includes six tables, namely, two tables displaying the names of each of the calendar months, two tables displaying the days of each of the calendar months, and two tables displaying various calendar years. Each table displaying the months includes twelve indicia. Each rectangle refers to one of the calendar months (e.g. January, February, March). Each table displaying days includes 40 indicia. 31 of these indicia contain numbers starting from 1 and finishing at 31. These numbers represent the different days of a calendar month. Each of the tables displaying years includes two tables, namely, a left table and a right table. The left table includes three indicia displaying the numbers 1, 2, 3, respectively. The right table includes 140 indicia. In these 140 indicia, there are three rows of years referring to each of the numbers of the left table. The first row of years begins with 1900 and finishes at 1937. The second row of years begins with 1938 and finishes at 1975. The third row of years begins with 1976 and finishes at 2013. The lottery operator chooses two separate dates with each year parameter, a total of six dates. If both players' numbers match any of the two lotteries operator's combination, a top payout is awarded.

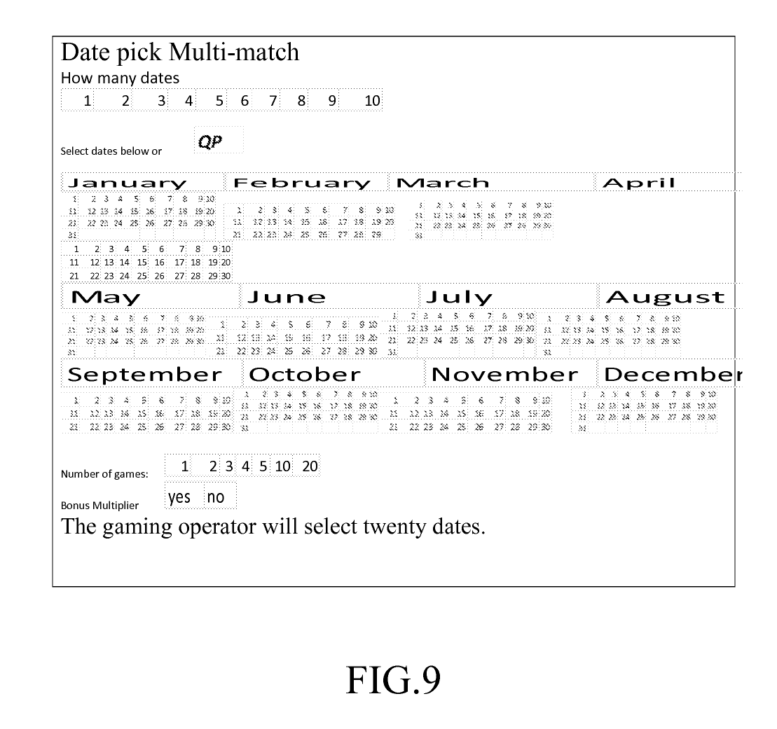

FIG. 9 refers to an embodiment of the game allowing the player to pick up to ten dates. At the top of FIG. 9, there is a calendar of a year including months and dates. At the bottom of FIG. 9, there is a text “Select number of games” and seven indicia displaying the following numbers, respectively: 1, 2, 3, 4, 5, 10, 20. By marking one of the indicia, the player chooses the number of games that he/she wants to play. At the bottom of FIG. 9, there is also a text “Bonus Multiplier” and two indicia displaying the following words, respectively: “Yes” and “No.” At the bottom of FIG. 9, there is also a text “The gaming operator will select twenty dates.” In this embodiment, a gaming operator can alternate the amount allowed to select and the amount that will be selected. In this embodiment, a gaming operator selects more than the maximum of what a player can select. For example, a gaming operator draws five or more dates and a player will only be allowed to pick a maximum of four dates.

In another embodiment a parameter can contain within it units that represent a plurality of points of time. For example [1901, 1929, 1957, 1985] would represent a single selection. Another example would be the days [28, 29] being a single selection.

In other embodiments a gaming operator can select from time units from various non-Gregorian calendars, including, but not limited to, the Chinese, Jewish, Indian, Korean, Vietnamese, and Japanese calendars.

In other embodiments, alternative variations could include time parameters representing minutes, hours, and weeks.

In the embodiments of FIGS. 6, 7, 8, and 9, substantially higher payouts can be offered where a player would be required of match a plurality of dates for a top payout. For example, a player would select two or three dates from a calendar year and a gaming operator would draw two or three dates and the highest payout would be awarded to a player that matches all dates to the gaming operators draw. For example, if a player picked November 1 and December 2 and matched both dates to the gaming operator's dates, the player would be entitled to a top payout. A gaming operator can also choose to award subordinate payouts for matching lesser variables. For example, if only December 2 is matched, a subordinate prize can be awarded to the player.

The exemplary embodiments of the game allows the player to play in relation to units of times. Additional advantages of exemplary embodiments of the game include, for example:
the game permits the player to pick plurality of days, months, and years for each play.
the game permits the gaming operator to select winners by picking one or more dates from a set of dates and assessing the extent to which the picked numbers match two or more dates picked by a player.
the game permits the gaming operator to select winners by picking at least a year from separate sets of years and assessing the extent to which the picked year match one or more years picked by a player from a set of years.
the game permits the players to pick dates from various civil calendars, including the Gregorian calendar.
the game permits the player to pick astrological signs.
the game permits the player to pick time parameters representing minutes, hours, and weeks.
the game permits the player to pick the full number of the year, e.g. 2012.
the game permits the gaming operator to select winners by relating the dates chosen by players to astrological signs (preferably from the Chinese zodiac) picked by the gaming operator.
the game permits the player to pick plurality of days, months and years for each play.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

I claim:

1. A game of chance comprising:
a variable representing days in a calendar year,
wherein a player selects a plurality of variables from a parameter representing a calendar year,
wherein the gaming operator draws a plurality of variables from a parameter representing a calendar year, and
wherein payouts for matching the corresponding said variables would be in correspondence to the combination of the said variables frequency of occurrence.

2. The game of chance according to claim 1, further comprising:
an option of a year parameter(s).

3. The game of chance according to claim 1, wherein subordinate payouts are awarded for matching part of the gaming operator's variables.

4. The game of chance according to claim 1, wherein a players selects less variables than a number of variables selected by the gaming operator.

5. The game of chance according to claim 1, wherein a player selects more variables than a number of variables drawn by the gaming operator.

6. The game of chance according to claim 1, wherein a gaming operator draws more variables than a maximum number of variables that a player is permitted to select.

7. The game of chance according to claim 1, wherein a top value payout is a progressive payout.

8. The game of chance according to claim 1, further comprising a bonus multiplier.

9. The game of chance according to claim 1, further comprising an instant ticket game.

10. The game of chance according to claim 1, further comprising a secondary drawing for ticketholders.

11. The game of chance according to claim 9, further comprising a secondary drawing for ticketholders.

12. A method of playing a draw game, the method comprising:
executing instructions on a processor in a computer to implement the following operations: receiving a wager from a player; the player selects from indicia that represent units of a time at least a day from a calendar year and at least a year from a plurality of year sets; a gaming operator selects variables that correspond to the selection provided to the player, which variables include at least a day from a calendar year and at least a year from the each of the said plurality of year sets; resolving the players wager; and determining whether or not the player wins or loses the game according to the results of the draw.

13. The method of claim 1, wherein the year sets have an equal amount of leap years and non-leap years.

14. A method of playing a draw game, the method comprising:
executing instructions on a processor in a computer to implement the following operations: receiving a wager from a player; the player selects at least a day from indicia that represents a year in a calendar year; a gaming operator selects a plurality of days from variables that correspond to the players indicia; resolving the players wager; and determining whether the player wins or loses the game according to the results of the draw.

15. The method of claim 14, wherein the indicia are arranged in a grid position resembling a calendar year with each indicia representing a day in a calendar year.

16. The method of claim 14, wherein a player selects more variables than what the gaming operator draws.

17. The method of claim 14, wherein a gaming operator draws more variables than what the maximum a player is permitted to select.

18. The method of claim 14, wherein a player has the option of the selecting a number of variables to draw.

19. The method of claim 14, wherein a payout progressively increases in subsequent drawings when there are no winners.

20. The method of claim 3, wherein for at least some value payouts the value payout is different than a sum of a plurality of individual value payouts.

21. A method of playing a draw game, the method comprising:
executing instructions on a processor in a computer to implement the following operations: receiving a wager from a player; the player selects from indicia that represent units of a time at least a day from a calendar year and selects from indicia that represent a zodiac; the player selects at least an indicia that represents a day from the said calendar year and, at least an indicia that represents a zodiac; a gaming operator selects at least a day and at least a month from a calendar year; resolving the players wager; and determining whether the player wins or loses the game according to the results of the draw.

22. The method of claim 21, wherein the zodiac comprises indicia representing astrological constellations.

23. The method of claim 21, wherein the zodiac comprises indicia representing Chinese years.

24. An apparatus for playing a draw game, the apparatus comprising:
a control device programmed to control an operation of the draw game, the control device programmed to receive an input of a wager from a player, wherein the player selects from indicia that represent units of a time, at least a day from a calendar year, and at least a year from a plurality of year sets;
wherein the control device is programmed to select variables that correspond to the selection input by the player, wherein the variables include at least a day from a calendar year and at least a year from each of the plurality of year sets,
wherein the control device is programmed to resolve the player's wager and determine whether or not the player wins or loses the game according to the results of the draw.
